(19) United States
(12) Patent Application Publication
(10) Pub. No.: US 2022/0373937 A1
(43) Pub. Date: Nov. 24, 2022

(54) CONDUCTIVE ROLLER, TRANSFER DEVICE, PROCESS CARTRIDGE, AND IMAGE FORMING APPARATUS

(71) Applicant: FUJIFILM Business Innovation Corp., Tokyo (JP)

(72) Inventors: Takuro HOSHIO, Kanagawa (JP); Minoru Rokutan, Kanagawa (JP); Shogo Hayashi, Kanagawa (JP)

(73) Assignee: FUJIFILM Business Innovation Corp., Tokyo (JP)

(21) Appl. No.: 17/405,146

(22) Filed: Aug. 18, 2021

(30) Foreign Application Priority Data
May 19, 2021 (JP) 2021-084938

(51) Int. Cl. G03G 15/16

(52) U.S. Cl. CPC G03G 15/162

(57) ABSTRACT

A conductive roller includes a support member, an elastic layer disposed on an outer peripheral surface of the support member, an intermediate layer disposed on an outer peripheral surface of the elastic layer, and a surface layer disposed on an outer peripheral surface of the intermediate layer. The elastic layer includes a cylindrical elastic foam and a conductive covering layer covering an exposed surface of the elastic foam. The Young's modulus Yd of the elastic layer and the Young's modulus Ym of the intermediate layer satisfy the relationship Yd<Ym.

### CROSS-REFERENCE TO RELATED APPLICATIONS

This application is based on and claims priority under 35 USC 119 from Japanese Patent Application No. 2021-084938 filed May 19, 2021.

### BACKGROUND

### (i) Technical Field

The present disclosure relates to conductive rollers, transfer devices, process cartridges, and image forming apparatuses.

### (ii) Related Art

Japanese Unexamined Patent Application Publication No. 2003-005505 discloses a semiconductive image forming member including a semiconductive elastomer layer disposed on an outer peripheral surface of a conductive substrate and a coating composed of first and second layers stacked in that order on a surface of the elastomer layer. The Young's modulus of the coating is as follows: 1.0×10⁴ (Pa)<Young's modulus of first layer material<Young's modulus of second layer material<1.0×10¹⁰ (Pa).

Japanese Unexamined Patent Application Publication No. 2004-212865 discloses a semiconductive roller for use in a developing device that makes visible an electrostatic latent image formed on a latent image carrier. The semiconductive roller includes a conductive shaft, at least one elastic semiconductive layer disposed around the conductive shaft, and a toner carrying layer disposed around the elastic semiconductive layer and formed of a thermosetting polymer or a thermoplastic polymer. The toner carrying layer carries triboelectrically charged toner in the form of a thin layer. The toner carrying layer has a static friction coefficient of 0.1 to 1.5 and a Young's modulus of 1 to 6,500 MPa.

### SUMMARY

Aspects of non-limiting embodiments of the present disclosure relate to a conductive roller that is used to form a passage area through which a medium passes by pressing an outer peripheral surface of the conductive roller against a counter roller and that provides high releasability of a medium passing through the passage area compared to a conductive roller in which the Young's modulus Yd of an elastic layer is higher than the Young's modulus of an intermediate layer.

“High releasability of a medium passing through the passage area” is hereinafter also simply referred to as “high medium releasability”

Here, examples of media that pass through the passage area include sheets of paper for use in electrophotographic copiers and printers, as described later; resin films such as OHP sheets; and displays and package sheets.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a conductive roller comprising a support member, an elastic layer disposed on an outer peripheral surface of the support member, an intermediate layer disposed on an outer peripheral surface of the elastic layer, and a surface layer disposed on an outer peripheral surface of the intermediate layer, wherein the elastic layer includes a cylindrical elastic foam and a conductive covering layer covering an exposed surface of the elastic foam, and the Young's modulus Yd of the elastic layer and the Young's modulus Ym of the intermediate layer satisfy the relationship Yd<Ym.

### BRIEF DESCRIPTION OF THE DRAWINGS

An exemplary embodiment of the present disclosure will be described in detail based on the following figures, wherein:

FIG. 1 is a schematic perspective view illustrating an example conductive roller according to the present exemplary embodiment;

FIG. 2 is a schematic sectional view illustrating the example conductive roller according to the present exemplary embodiment and is a sectional view taken along line II-II in FIG. 1;

FIG. 3 is a schematic diagram illustrating an example image forming apparatus according to the present exemplary embodiment; and

FIG. 4 is a schematic diagram illustrating another example image forming apparatus according to the present exemplary embodiment.

### DETAILED DESCRIPTION

An exemplary embodiment of the present disclosure will be described below. The following description and Examples are merely illustrative of the exemplary embodiment and are not intended to limit the scope of the exemplary embodiment.

In the present disclosure, a numerical range expressed using “to” refers to a range including the values recited before and after “to” as the minimum and maximum values, respectively.

For numerical ranges recited stepwise in the present disclosure, the upper or lower limit of one numerical range may be replaced by the upper or lower limit of another one of the numerical ranges recited stepwise. In addition, the upper or lower limit of a numerical range recited in the present disclosure may be replaced by a value shown in the Examples.

In the present disclosure, the term “step” includes not only an independent step, but also a step that cannot be clearly distinguished from other steps as long as the intended purpose of that step is achieved.

When the exemplary embodiment is described with reference to the drawings in the present disclosure, the configuration of the exemplary embodiment is not limited to those illustrated in the drawings. In addition, the sizes of the members in the drawings are merely conceptual, and the relative relationship between the sizes of the members is not limited thereto.

In the present disclosure, each component may include a plurality of materials of that category. When the amount of each component in a composition is mentioned in the present disclosure, it refers to, if there are a plurality of materials of that category in the composition, the total amount of those materials in the composition unless otherwise specified.

### Conductive Roller

A conductive roller according to the present exemplary embodiment comprises a support member, an elastic layer disposed on an outer peripheral surface of the support member, an intermediate layer disposed on an outer peripheral surface of the elastic layer, and a surface layer disposed on an outer peripheral surface of the intermediate layer. The elastic layer includes a cylindrical elastic foam and a conductive covering layer covering an exposed surface of the elastic foam. The Young's modulus Yd of the elastic layer and the Young's modulus Ym of the intermediate layer satisfy the relationship Yd<Ym.

The purpose of the conductive roller according to the present exemplary embodiment is not particularly limited as long as the conductive roller is used to form a passage area through which a recording medium passes by pressing the outer peripheral surface of the conductive roller against a counter roller. That is, the outer peripheral surface of the conductive roller according to the present exemplary embodiment is pressed against a counter roller to form a pressing region serving as a passage area.

The conductive roller according to the present exemplary embodiment may be used as, for example, a transfer roller or a recording medium transport roller for an electrophotographic image forming apparatus. The purpose of the conductive roller according to the present exemplary embodiment is not limited to those mentioned above.

When an outer peripheral surface of a conductive roller is pressed against a counter roller to form a passage area through which a medium passes, the medium may be wound around the conductive roller. This may decrease the releasability of the medium from the conductive roller.

A conductive roller in the related art includes, for example, a support member and an elastic layer disposed on an outer peripheral surface of the support member. When the conductive roller is pressed against a counter roller, the shape of the elastic layer deforms so as to conform to the shape of the counter roller. In this case, the outer peripheral surface of the conductive roller deforms so as to be wound around the outer peripheral surface of the counter roller. Such deformation of the outer peripheral surface of the conductive roller causes a medium to be wound around the conductive roller, as described above. A thinner medium would more readily be wound around the conductive roller.

For the conductive roller according to the present exemplary embodiment, the elastic layer, the intermediate layer, and the surface layer are stacked in that order on the outer peripheral surface of the support member. The elastic layer includes the cylindrical elastic foam and the conductive covering layer covering the exposed surface of the elastic foam. The Young's modulus Yd of the elastic layer and the Young's modulus Ym of the intermediate layer satisfy the relationship Yd<Ym.

For the conductive roller according to the present exemplary embodiment, the elastic layer includes the cylindrical elastic foam and the conductive covering layer covering the exposed surface of the elastic foam. The elastic layer may be provided with the intended conductivity by the conductive covering layer; therefore, a soft elastic layer may be obtained compared to an elastic foam containing a conductor. A conductive roller having a soft elastic layer may allow a passage area for a medium to be formed by pressing the outer peripheral surface of the conductive roller against a counter roller.

In addition, the intermediate layer, which is disposed on the outer side of the conductive roller, has a higher Young's modulus than the elastic layer, which is disposed on the inner side of the conductive roller. Therefore, when the conductive roller is pressed against a counter roller, the outer peripheral surface of the conductive roller may deform into a flat shape and may be unlikely to deform so as to conform to the shape of the counter roller. That is, the deformation of the outer peripheral surface of the conductive roller so as to be wound around the outer peripheral surface of the counter roller may be reduced.

As a result, when the conductive roller according to the present exemplary embodiment is used to form a passage area through which a medium passes by pressing the outer peripheral surface of the conductive roller against a counter roller, good releasability of a medium passing through the passage area may be achieved.

From the viewpoint of high medium releasability on the conductive roller according to the present exemplary embodiment, the Young's modulus Yd of the elastic layer and the Young's modulus Ym of the intermediate layer preferably satisfy the relationship 10≤Ym/Yd≤100, more preferably the relationship 15≤Ym/Yd≤80, even more preferably the relationship 20≤Ym/Yd≤70.

From the viewpoint of high medium releasability on the conductive roller according to the present exemplary embodiment, the Young's modulus Yd of the elastic layer is preferably 50 kPa or more and 500 kPa or less, more preferably 60 kPa or more and 300 kPa or less, even more preferably 80 kPa or more and 150 kPa or less.

Such Young's moduli may be readily achieved by reducing the amount of particles (e.g., an electronic conductor or a filler) present in the elastic foam.

From the viewpoint of higher medium releasability on the conductive roller according to the present exemplary embodiment, the Young's modulus Ym of the intermediate layer and the Young's modulus Ys of the surface layer may satisfy the relationship Ym<Ys.

For the same reason, the Young's modulus Ym of the intermediate layer and the Young's modulus Ys of the surface layer preferably satisfy the relationship 5≤Ys/Ym≤100, more preferably the relationship 10≤Ys/Ym≤80, even more preferably the relationship 15≤Ys/Ym≤70.

The Young's modulus of each layer is measured as follows.

The method for measuring the Young's modulus of each layer basically conforms to ISO 527.

For the intermediate layer and the elastic layer, a dumbbell-shaped tensile test specimen with a gauge length of 50 mm and a thickness of 5 mm is prepared and used to obtain a stress (σ)-strain (ε) curve at a tensile speed of 5 mm/min with a tabletop precision universal tester (AGS-X; manufactured by Shimadzu Corporation). The stress at a strain of 0.05% to 0.25% is measured, and the Young's modulus is calculated from Δσ/Δε.

The Young's modulus of the surface layer may be determined by the same method as those of the intermediate layer and the elastic layer except that a dumbbell-shaped tensile test specimen with a thickness of 0.2 mm is prepared and used.

The conductive roller according to the present exemplary embodiment will be described with reference to the drawings.

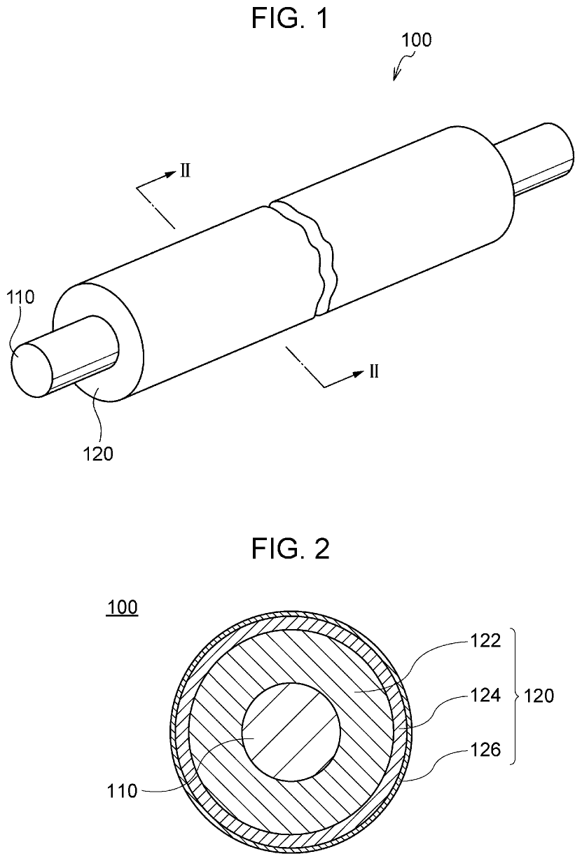

FIG. 1 is a schematic perspective view illustrating an example conductive roller according to the present exemplary embodiment. FIG. 2 is a sectional view taken along line II-II in FIG. 1 and is a sectional view taken in the radial direction of the conductive roller illustrated in FIG. 1.

As illustrated in FIG. 1, the conductive roller 100 is a roller member including a cylindrical support member 110 and a layered member 120 including an elastic layer, an intermediate layer, and a surface layer stacked on an outer peripheral surface of the support member 110. As illustrated in FIG. 2, the layer structure of the conductive roller 100 includes an elastic layer 122 disposed on the outer peripheral surface of the cylindrical support member 110, an intermediate layer 124 disposed on an outer peripheral surface of the elastic layer 122, and a surface layer 126 disposed on an outer peripheral surface of the intermediate layer 124.

The conductive roller according to the present exemplary embodiment is not limited to the configuration illustrated in FIGS. 1 and 2. For example, the conductive roller according to the present exemplary embodiment may include an adhesive layer between the support member 110 and the elastic layer 122, between the elastic layer 122 and the intermediate layer 124, or between the intermediate layer 124 and the surface layer 126 where appropriate.

The materials and other details of the individual layers forming the conductive roller according to the present exemplary embodiment will be described below.

### Support Member

The support member of the conductive roller according to the present exemplary embodiment may be any member that functions as a support member for the conductive roller.

The support member may be a hollow member (i.e., a hollow cylindrical member) or a solid member (i.e., a solid cylindrical member).

When an electric field is formed between the conductive roller and a counter roller, the support member may be a conductive support member.

Examples of conductive support members include metal members such as those formed of iron (e.g., free-cutting steel), copper, brass, stainless steel, aluminum, and nickel; resin or ceramic members having the outer surfaces thereof subjected to plating treatment; and resin or ceramic members containing conductors.

The outer diameter of the support member may be determined depending on the purpose of the conductive roller.

For example, if the conductive roller according to the present exemplary embodiment is a second transfer roller, the support member may have an outer diameter of, for example, 3 mm or more and 30 mm or less.

Elastic Layer

The elastic layer of the conductive roller according to the present exemplary embodiment includes a cylindrical elastic foam and a conductive covering layer covering an exposed surface of the elastic foam.

Elastic Foam

The elastic foam forming the elastic layer is a foam containing an elastic material (also referred to as “rubber material”).

Examples of elastic materials include isoprene rubber, chloroprene rubber, epichlorohydrin rubber, butyl rubber, polyurethane, silicone rubber, fluorocarbon rubber, styrene-butadiene rubber, butadiene rubber, nitrile rubber, ethylene-propylene rubber, epichlorohydrin-ethylene oxide copolymer rubber, epichlorohydrin-ethylene oxide-allyl glycidyl ether terpolymer rubber, ethylene-propylene-diene terpolymer rubber (EPDM), acrylonitrile-butadiene copolymer rubber (NBR), natural rubber, and mixtures thereof.

Examples of blowing agents for obtaining the elastic foam include water; azo compounds such as azodicarbonamide, azobisisobutyronitrile, and diazoaminobenzene; benzenesulfonyl hydrazides such as benzenesulfonyl hydrazide, 4,4′-oxybisbenzenesulfonyl hydrazide, and toluenesulfonyl hydrazide; bicarbonate salts that generate carbon dioxide gas by thermal decomposition, such as sodium hydrogen carbonate; mixtures of NaNO₂ and NH₄Cl that generate nitrogen gas; and peroxides that generate oxygen.

To obtain the elastic foam, additives such as blowing aids, foam stabilizers, and catalysts may optionally be used.

The elastic foam may contain a conductor from the viewpoint of conductivity control of the elastic layer.

Examples of conductors that may be present in the elastic foam include electronic conductors and ionic conductors.

From the viewpoint of controlling the Young's modulus Yd of the elastic layer within the range described above, the amount of conductor present in the elastic foam (particularly, in the case of an electronic conductor) may be 1% by mass or less, preferably 0.5% by mass or less, more preferably 0% by mass, based on the total mass of the elastic foam.

That is, the elastic foam may contain a smaller amount of electronic conductor. If the elastic foam contains conductive particles, the amount of electronic conductor may be 1% by mass or less based on the total mass of the elastic foam.

Examples of electronic conductors include powders of the following materials: carbon black such as ketjen black and acetylene black; pyrolytic carbon; graphite; metals and alloys such as aluminum, copper, nickel, and stainless steel; conductive metal oxides such as tin oxide, indium oxide, titanium oxide, tin oxide-antimony oxide solid solutions, and tin oxide-indium oxide solid solutions; and insulating materials having the surfaces thereof treated to be conductive.

These electronic conductors may be used alone or in a combination of two or more thereof.

Examples of ionic conductors include quaternary ammonium salts (e.g., perchlorate salts, chlorate salts, fluoroborate salts, sulfate salts, ethosulfate salts, benzyl bromide salts, and benzyl chloride salts of lauryltrimethylammonium, stearyltrimethylammonium, octadecyltrimethylammonium, dodecyltrimethylammonium, hexadecyltrimethylammonium, and modified fatty acid-dimethylethylammonium), aliphatic sulfonic acid salts, higher alcohol sulfate ester salts, higher alcohol ethylene oxide adduct sulfate ester salts, higher alcohol phosphate ester salts, higher alcohol ethylene oxide adduct phosphate ester salts, betaine, higher alcohol ethylene oxide adducts, polyethylene glycol fatty acid esters, and polyhydric alcohol fatty acid esters.

These ionic conductor may be used alone or in a combination of two or more thereof.

Examples of other additives include known materials that can be added to elastomers, such as softeners, plasticizers, curing agents, vulcanizing agents, vulcanization accelerators, antioxidants, surfactants, coupling agents, and fillers (e.g., silica and calcium carbonate).

If the elastic foam contains particles such as electronic conductors and fillers as mentioned above, the elastic layer exhibits increased hardness, which tends to result in decreased medium releasability. Accordingly, the elastic foam may contain a smaller amount of particles. If the elastic foam contains particles, the total amount of particles may be 1% by mass or less based on the total mass of the elastic foam.

The cell structure of the elastic foam may be an open-cell structure from the viewpoint of suitability for formation of the conductive covering layer and high medium releasability.

Here, “open-cell structure” refers to a structure in which neighboring cells (i.e., pores) connect to each other, with some of the connecting cells being exposed (open) on the surface.

The elastic foam may have a smaller percentage of closed cells. For example, the percentage of closed cells may be 50% or less (more preferably 30% or less).

From the viewpoint of suitability for formation of the conductive covering layer and high medium releasability, the elastic foam preferably has a cell size (also referred to as “pore size”) of 50 μm or more and 1,000 μm or less, more preferably 100 μm or more and 800 μm or less, even more preferably 150 μm or more and 600 μm or less.

From the viewpoint of suitability for formation of the conductive covering layer and high medium releasability, the elastic foam preferably has a density (also referred to as “porosity”) of 50 kg/m³ or more and 90 kg/m³ or less, more preferably 55 kg/m³ or more and 85 kg/m³ or less, even more preferably 60 kg/m³ or more and 80 kg/m³ or less.

Here, the cell size (pore size), percentage of cells (porosity), and percentage of closed cells of the elastic foam are measured as follows.

First, cross-sections of the elastic layer (i.e., the elastic foam in the elastic layer) in the thickness direction are prepared using a razor. A total of four cross-sections are prepared by cutting the elastic layer parallel to the axial direction of the conductive roller at intervals of 90° in the circumferential direction.

An image of the center of each cross-section in the axial direction is captured under a laser microscope (Keyence Corporation, VK-X200). The image is analyzed with image analysis software (Media Cybernetics, Inc., Image-Pro Plus) to measure the maximum sizes and areas of cells (pores).

If the elastic foam has an open-cell structure, the state in which cells (pores) connect to each other is estimated from the shape of open cells. The individual connecting (linking) cells are virtually separated from each other, and the maximum sizes of the separated cells are determined. Specifically, for example, if the open cells are estimated to have a shape in which five cells connect (link) to each other, the five cells are virtually separated into five, and the maximum sizes of the five separated cells are measured.

The cell size is determined by calculating the arithmetic mean of the maximum sizes of 100 cells randomly selected from each cross-sectional image analyzed and, based on the resulting values, calculating the arithmetic mean of the four cross-sections.

The percentage of cells can be determined as (total area of cells in cross-sectional image analyzed)/(total area of cross-sectional image analyzed)×100.

The percentage of closed cells can be determined as (total area of closed cells in cross-sectional image analyzed)/(total area of cells in cross-sectional image analyzed)×100.

Here, closed cells are defined as cells that are completely enclosed by wall surfaces in cross-sectional images.

The density of the elastic foam is measured as follows.

A cube is prepared from the elastic layer (i.e., the elastic foam in the elastic layer) with a razor. The use of as large a cube as possible may allow for accurate density measurement. The length, width, and height of the cube are then measured, and the volume is calculated. The weight is measured, and the density is determined as weight/volume.

### Formation of Elastic Foam

The method for forming the cylindrical elastic foam is not particularly limited, and known methods may be used.

Examples of methods for forming the cylindrical elastic foam include a method in which a composition containing an elastic material, a blowing agent, and optionally other ingredients (e.g., a vulcanizing agent) is prepared, is formed into a hollow cylindrical shape by extrusion molding, and is vulcanized and foamed by heating; and a method in which a large foam is cut into a hollow cylindrical shape.

The cylindrical elastic foam may also be obtained by forming a solid cylindrical elastic foam and then forming a central hole for insertion of the support member.

The thus-obtained cylindrical elastic foam may optionally be further subjected to post processing such as shape trimming and surface polishing.

### Conductive Covering Layer

The elastic layer may include a conductive covering layer covering the exposed surface of the elastic foam (i.e., the surface of the elastic foam in contact with air, including the inner peripheral surface, outer peripheral surface, and cell wall surfaces of the cylindrical elastic foam).

The exposed surface of the elastic foam may be partially or completely covered by the conductive covering layer.

The conductive covering layer is formed from a treatment liquid containing a conductor and a resin.

Here, the conductor used in the treatment liquid may be, for example, an electronic conductor or an ionic conductor, preferably an electronic conductor.

The treatment liquid may contain one or more conductors.

Here, examples of electronic conductors are similar to those that may be present in the elastic foam.

The resin used in the treatment liquid is not particularly limited as long as the resin can form a covering layer on the exposed surface of the elastic foam. Examples of such resins include acrylic resins, urethane resins, fluorocarbon resins, and silicone resins. These resins may be used as a latex.

Examples of latexes include latexes of the resins mentioned above, natural rubber latex, butadiene rubber latex, acrylonitrile-butadiene rubber latex, acrylic rubber latex, polyurethane rubber latex, fluorocarbon rubber latex, and silicone rubber latex.

The treatment liquid may contain a conductor, a resin, and water. That is, the treatment liquid may be an aqueous dispersion containing a conductor and a resin.

The concentrations of the conductor and the resin in the treatment liquid may be determined depending on, for example, suitability for formation of the conductive covering layer and the target resistance value of the elastic layer.

### Formation of Conductive Covering Layer

The conductive covering layer is formed by applying the treatment liquid to the elastic foam and then drying the coating by heating.

Examples of methods for applying the treatment liquid to the elastic foam include a method in which the treatment liquid is applied to the elastic foam by a technique such as spraying and a method in which the elastic foam is immersed in the treatment liquid.

By such methods, the surface of the elastic foam and the interior of the cells are impregnated with the treatment liquid. The deposited treatment liquid is then dried by a technique such as heating to form the conductive covering layer.

For example, a covering layer and a method for forming the covering layer that are described in Japanese Unexamined Patent Application Publication No. 2009-244824 may be used for the conductive covering layer.

By forming the conductive covering layer on the exposed surface of the elastic foam as described above, the elastic layer of the conductive roller according to the present exemplary embodiment is formed.

### Volume Resistance Value of Elastic Layer

The elastic layer of the conductive roller according to the present exemplary embodiment preferably has a volume resistance value of 10⁵ Ω or less, more preferably 10¹ Ω or more and 10⁵ Ω or less, even more preferably 10² Ω or more and 10⁴ Ω or less, when a voltage of 10 V is applied to the elastic layer.

The volume resistance value of the elastic layer and a multilayer roller like the conductive roller according to the present exemplary embodiment is measured as follows.

For the elastic layer, a roller member having an elastic layer for measurement around the outer periphery of a conductive support member is first prepared. The resulting roller member is used to measure the volume resistance value of the elastic layer. If the conductive roller according to the present exemplary embodiment includes a conductive support member, a roller member obtained by removing the intermediate layer and the surface layer from the conductive roller may be used for measurement.

The roller member is placed on a metal plate such as a copper plate, with a load of 500 g applied to each end of the roller member. A voltage (V) of 10 V (for the elastic layer) is applied between the conductive support member of the roller member and the metal plate with a microammeter (R8320 manufactured by Advantest Corporation), and the current I (A) is read after five seconds. The volume resistance value can be determined by calculation using the following equation:

Equation: volume resistance value Rv (Ω)=V/I

The measurement is performed in an environment at a temperature of 22° C. and a humidity of 55% RH.

The volume resistance value of the multilayer roller including the intermediate layer and the surface layer in addition to the elastic layer is measured by the same method as the volume resistance value of the elastic layer. For the multilayer roller, a voltage (V) of 1,000 V is applied for measurement.

The volume resistance value of the intermediate layer and the surface layer is measured in accordance with JIS K 6911 as follows.

A sheet member is first prepared from the layer material, and the resulting sheet member is used to measure the volume resistance value. The thickness of the sheet member may be 1 mm for the intermediate layer and may be 0.2 mm for the surface layer.

The sheet member is placed between circular electrodes. A voltage (V) of 100 V for the intermediate layer or 50 V for the surface layer is applied between the front and back electrodes with a microammeter (R8320 manufactured by Advantest Corporation), and the current I (A) is read after five seconds. The volume resistance value can be determined by calculation using the following equation:

Equation: volume resistance value Rv (Ω)=V/I

The measurement is performed in an environment at a temperature of 22° C. and a humidity of 55% RH.

### Thickness of Elastic Layer

The thickness of the elastic layer of the conductive roller according to the present exemplary embodiment may be determined depending on the purpose of the conductive roller.

For example, if the conductive roller according to the present exemplary embodiment is a second transfer roller, the elastic layer may have a thickness of, for example, 1 mm or more and 10 mm or less.

From the viewpoint of the suitability of the conductive roller according to the present exemplary embodiment for use as a transfer roller, the thickness Td of the elastic layer, the thickness Tm of the intermediate layer, and the thickness Ts of the surface layer preferably satisfy the relationship Td>Tm>Ts and the relationship 0.05≤Td/(Td +Tm+Ts)≤0.45, more preferably the relationship 0.10≤Td/(Td+Tm+Ts)≤0.25.

### Intermediate Layer

The intermediate layer is a layer disposed on the outer peripheral surface of the elastic layer.

The intermediate layer serves as a layer that contributes to resistance adjustment of the conductive roller and preferably has a volume resistance value of 10⁴ Ω or more and 10⁹ Ω or less (more preferably 10⁶ Ω or more and 10⁹ Ω or less) when a voltage of 100 V is applied to the intermediate layer.

The volume resistance value of the intermediate layer is measured by the same method as the volume resistance value of the elastic layer.

To achieve the above volume resistance value, the intermediate layer may contain a conductor.

The conductor used may be an electronic conductor or an ionic conductor. In particular, an ionic conductor may be used from the viewpoint of enhanced charge retention.

That is, the intermediate layer may contain an ionic conductor. Examples of ionic conductors that may be present in the intermediate layer are similar to those that may be present in the elastic foam.

These ionic conductors may be used alone or in a combination of two or more thereof.

The ionic conductor used in the intermediate layer may also be a polymer material with ionic conductivity, such as epichlorohydrin rubber, epichlorohydrin-ethylene oxide copolymer rubber, or epichlorohydrin-ethylene oxide-allyl glycidyl ether terpolymer rubber.

The ionic conductor used in the intermediate layer may also be a compound having an ionic conductor attached to an end of a polymer material such as a resin.

The amount of ionic conductor may fall within a range in which the volume resistance value described above can be achieved.

If the intermediate layer contains a binder material, the amount of ionic conductor is preferably 0.1 parts by mass or more and 5.0 parts by mass or less, more preferably 0.5 parts by mass or more and 3.0 parts by mass or less, based on 100 parts by mass of the binder material.

In addition to the ionic conductor, the intermediate layer may contain a binder material.

The binder material is not particularly limited. Examples of binder materials include resins and elastic materials that can form the intermediate layer. Examples of resins that may be used in the intermediate layer include urethane resins, acrylic resins, epoxy resins, and silicone resins. Examples of elastic materials that may be present in the intermediate layer are similar to those that may be used in the elastic layers.

The intermediate layer may contain other additives depending on, for example, the target physical properties of the intermediate layer.

### Young's Modulus of Intermediate Layer

The intermediate layer preferably has a Young's modulus of 5 MPa or more, more preferably 5 MPa or more and 10 MPa or less.

The Young's modulus of the intermediate layer is measured by the same method as the Young's modulus of the elastic layer.

### Thickness of Intermediate Layer

The thickness of the intermediate layer of the conductive roller according to the present exemplary embodiment may be determined depending on the purpose of the conductive roller. The intermediate layer may be thinner than the elastic layer.

For example, if the conductive roller according to the present exemplary embodiment is a second transfer roller, the intermediate layer may have a thickness of, for example, 0.5 mm or more and 5 mm or less.

The method for forming the intermediate layer is not particularly limited. Examples of methods for forming the intermediate layer include a method in which a coating liquid for forming the intermediate layer is applied to the elastic layer and the resulting coating is dried.

### Surface Layer

The surface layer is a layer that is disposed on the outer peripheral surface of the intermediate layer and that forms the outermost surface of the conductive roller.

Because the surface layer comes into contact with media, the surface layer may have releasability.

The surface layer may be a layer containing a resin.

The resin present in the surface layer is not particularly limited. Examples of resins include urethane resins, polyester resins, phenolic resins, acrylic resins, epoxy resins, and cellulose resins.

The surface layer may contain a conductor.

The conductor present in the surface layer may be an electronic conductor or an ionic conductor.

Examples of electronic conductors that may be present in the surface layer are similar to those that may be used in the conductive covering layer. Examples of ionic conductors that may be present in the surface layer are similar to those that may be used in the intermediate layer.

The surface layer may contain other additives depending on, for example, the target physical properties of the surface layer.

### Young's Modulus of Surface Layer

The surface layer preferably has a Young's modulus of 50 MPa or more, more preferably 50 MPa or more and 400 MPa or less.

The Young's modulus of the surface layer is measured by the same method as the Young's modulus of the elastic layer.

### Thickness of Surface Layer

The thickness of the surface layer of the conductive roller according to the present exemplary embodiment may be determined depending on the purpose of the conductive roller.

For example, if the conductive roller according to the present exemplary embodiment is a second transfer roller, the surface layer may have a thickness of, for example, 0.01 mm or more and 0.05 mm or less.

### Volume Resistance Value of Surface Layer

The surface layer preferably has a volume resistance value of 10⁴ Ω or more and 10¹⁴ Ω or less, more preferably 10⁶ Ω or more and 10¹² Ω or less, when a voltage of 50 V is applied to the surface layer.

The volume resistance value of the surface layer is measured by the same method as the volume resistance value of the elastic layer.

The method for forming the surface layer is not particularly limited. Examples of methods for forming the surface layer include a method in which a coating liquid for forming the surface layer is applied to the intermediate layer and the resulting coating is dried.

### Volume Resistance Value of Conductive Roller

The conductive roller according to the present exemplary embodiment preferably has a volume resistance value of 10⁴ Ω or more and 10¹² Ω or less, more preferably 10⁵ Ω or more and 10¹¹ Ω or less, even more preferably 10⁶ Ω or more and 10¹⁰ Ω or less, when a voltage of 1,000 V is applied to the conductive roller.

The volume resistance value of the conductive roller is measured by the same method as the volume resistance value of the elastic layer.

### Image Forming Apparatus, Transfer Device, and Process Cartridge

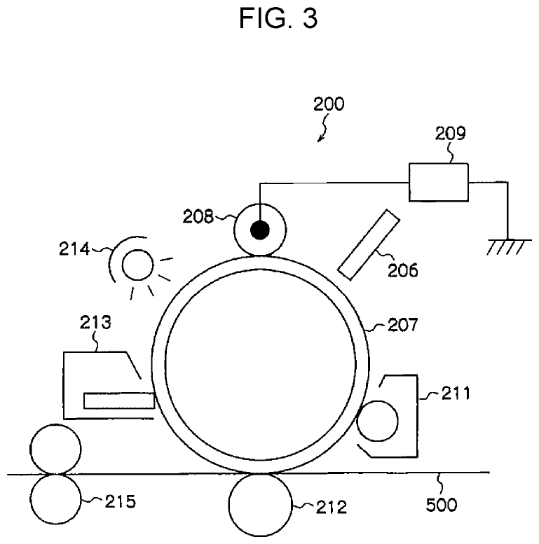

FIG. 3 is a schematic diagram illustrating a direct-transfer image forming apparatus serving as an example image forming apparatus according to the present exemplary embodiment.

The image forming apparatus 200 illustrated in FIG. 3 includes a photoreceptor 207 (an example of an image carrier), a charging roller 208 (an example of a charging section) that charges a surface of the photoreceptor 207, an exposure device 206 (an example of an electrostatic image forming section) that forms an electrostatic image on the charged surface of the photoreceptor 207, a developing device 211 (an example of a developing section) that develops the electrostatic image formed on the surface of the photoreceptor 207 with a developer containing toner to form a toner image, and a transfer roller 212 (an example of a transfer section, an example of a transfer device according to the present exemplary embodiment) that transfers the toner image formed on the surface of the photoreceptor 207 to a surface of a recording medium.

Here, the conductive roller according to the present exemplary embodiment is used as the transfer roller 212 to form a passage area through which a sheet of recording paper 500 passes by pressing the outer peripheral surface of the transfer roller 212 against the photoreceptor 207, which serves as a counter roller.

The image forming apparatus 200 illustrated in FIG. 3 further includes a cleaning device 213 that removes residual toner from the surface of the photoreceptor 207, an erase device 214 that erases charge from the surface of the photoreceptor 207, and a fixing device 215 (an example of a fixing section) that fixes a toner image to a recording medium.

The charging roller 208 may be a contact charging roller or a noncontact charging roller. A power supply 209 applies a voltage to the charging roller 208.

The exposure device 206 may be an optical device including a light source such as a semiconductor laser or a light emitting diode (LED).

The developing device 211 is a device that supplies toner to the photoreceptor 207. For example, the developing device 211 includes a developer carrying roller in contact with or in proximity to the photoreceptor 207 and deposits toner on an electrostatic image on the photoreceptor 207 to form a toner image.

The transfer roller 212 is a transfer roller that comes into direct contact with a surface of a recording medium and is disposed at a position opposite the photoreceptor 207. A sheet of recording paper 500 (an example of a recording medium) is fed into a gap where the transfer roller 212 is in contact with the photoreceptor 207 via a feed mechanism. When a transfer bias is applied to the transfer roller 212, electrostatic force directed from the photoreceptor 207 toward the recording paper 500 acts on the toner image, thereby transferring the toner image from the photoreceptor 207 to the recording paper 500.

The fixing device 215 may be, for example, a heat fixing device including a heating roller and a pressing roller pressed against the heating roller.

The cleaning device 213 may be a device including a cleaning member such as a blade, a brush, or a roller.

The erase device 214 is, for example, a device that irradiates the surface of the photoreceptor 207 with light after transfer to erase residual potential from the photoreceptor 207.

For example, the photoreceptor 207 and the transfer roller 212 may be integrated together with one housing to form a cartridge structure (process cartridge according to the present exemplary embodiment) attachable to and detachable from an image forming apparatus. The cartridge structure (process cartridge according to the present exemplary embodiment) may further include at least one selected from the group consisting of the charging roller 208, the exposure device 206, the developing device 211, and the cleaning device 213.

The image forming apparatus may be a tandem image forming apparatus in which a plurality of image forming units are arranged side-by-side, each including the photoreceptor 207, the charging roller 208, the exposure device 206, the developing device 211, the transfer roller 212, and the cleaning device 213.

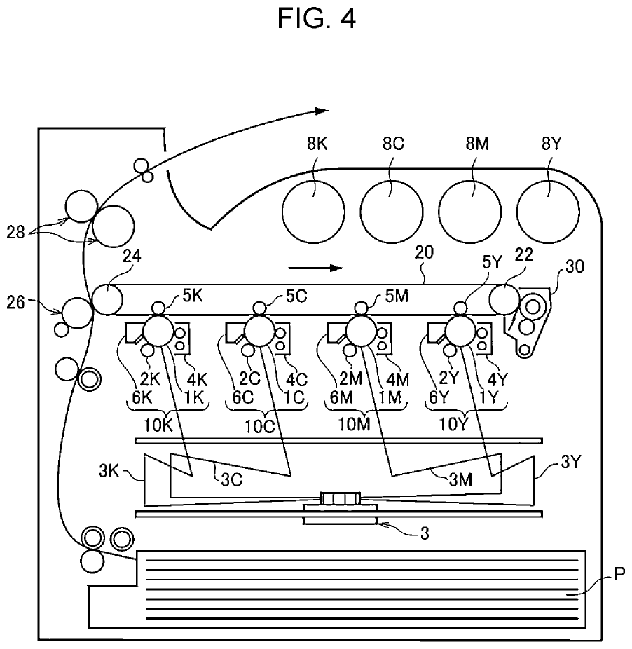

FIG. 4 is a schematic diagram illustrating an intermediate-transfer image forming apparatus serving as an example image forming apparatus according to the present exemplary embodiment. The image forming apparatus illustrated in FIG. 4 is a tandem image forming apparatus in which four image forming units are arranged side-by-side.

In the image forming apparatus illustrated in FIG. 4, a transfer section that transfers a toner image formed on a surface of an image carrier to a surface of a recording medium is configured as a transfer unit (an example of a transfer device according to the present exemplary embodiment) including an intermediate transfer body, a first transfer section, and a second transfer section. The transfer unit may be a cartridge structure attachable to and detachable from an image forming apparatus.

The image forming apparatus illustrated in FIG. 4 includes photoreceptors 1 (an example of an image carrier), charging rollers 2 (an example of a charging section) that charge surfaces of the photoreceptors 1, an exposure device 3 (an example of an electrostatic image forming section) that forms electrostatic images on the charged surfaces of the photoreceptors 1, developing devices 4 (an example of a developing section) that develop the electrostatic images formed on the surfaces of the photoreceptors 1 with developers containing toner to form toner images, an intermediate transfer belt 20 (an example of an intermediate transfer body), first transfer rollers 5 (an example of a first transfer section) that transfer the toner images formed on the surfaces of the photoreceptors 1 to a surface of the intermediate transfer belt 20, and a second transfer roller 26 (an example of a second transfer section) that transfers the toner images transferred to the surface of the intermediate transfer belt 20 to a surface of a recording medium.

Here, the conductive roller according to the present exemplary embodiment is used as the second transfer roller 26 to form a passage area through which a sheet of recording paper P passes by pressing the outer peripheral surface of the second transfer roller 26 against a support roller 24 serving as a counter roller.

The image forming apparatus illustrated in FIG. 4 further includes a fixing device 28 (an example of a fixing section) that fixes a toner image to a recording medium, photoreceptor cleaning devices 6 that remove residual toner from the surfaces of the photoreceptors 1, and an intermediate transfer belt cleaning device 30 that removes residual toner from the surface of the intermediate transfer belt 20.

The image forming apparatus illustrated in FIG. 4 includes first to fourth electrophotographic image forming units 10Y, 10M, 10C, and 10K that produce yellow (Y), magenta (M), cyan (C), and black (K) images, respectively, based on image data subjected to color separation. These image forming units 10Y, 10M, 10C, and 10K are arranged side-by-side at intervals in the horizontal direction. The image forming units 10Y, 10M, 10C, and 10K may each be a process cartridge attachable to and detachable from an image forming apparatus.

The intermediate transfer belt 20 extends over the image forming units 10Y, 10M, 10C, and 10K so as to pass through each image forming unit. The intermediate transfer belt 20 is wound around a drive roller 22 and a support roller 24 in contact with the inner surface of the intermediate transfer belt 20 so as to run in the direction from the first image forming unit 10Y toward the fourth image forming unit 10K. A spring or other member (not illustrated) applies force to the support roller 24 in the direction away from the drive roller 22, thereby applying tension to the intermediate transfer belt 20 wound therearound. The intermediate transfer belt cleaning device 30 is disposed opposite the drive roller 22 on the image carrying side of the intermediate transfer belt 20.

The developing devices 4Y, 4M, 4C, and 4K of the image forming units 10Y, 10M, 10C, and 10K are supplied with yellow, magenta, cyan, and black toners, respectively, contained in toner cartridges 8Y, 8M, 8C, and 8K.

The first to fourth image forming units 10Y, 10M, 10C, and 10K have similar configurations and perform similar operations; therefore, the first image forming unit 10Y will be described as a representative example in the following description of the image forming units.

The first image forming unit 10Y includes a photoreceptor 1Y, a charging roller 2Y that charges a surface of the photoreceptor 1Y, a developing device 4Y that develops an electrostatic image formed on the surface of the photoreceptor 1Y with a developer containing toner to form a toner image, a first transfer roller 5Y that transfers the toner image formed on the surface of the photoreceptor 1Y to a surface of the intermediate transfer belt 20, and a photoreceptor cleaning device 6Y that removes residual toner from the surface of the photoreceptor 1Y after the first transfer.

The charging roller 2Y charges the surface of the photoreceptor 1Y. The charging roller 2Y may be a contact charging roller or a noncontact charging roller.

The charged surface of the photoreceptor 1Y is irradiated with a laser beam 3Y from the exposure device 3. Thus, an electrostatic image of a yellow image pattern is formed on the surface of the photoreceptor 1Y.

The developing device 4Y contains, for example, an electrostatic image developer containing at least a yellow toner and a carrier. The yellow toner is triboelectrically charged inside the developing device 4Y by stirring. As the surface of the photoreceptor 1Y passes through the developing device 4Y, the electrostatic image formed on the photoreceptor 1Y is developed to form a toner image.

The first transfer roller 5Y is disposed inside the intermediate transfer belt 20 at a position opposite the photoreceptor 1Y. A bias power supply (not illustrated) for applying a first transfer bias is connected to the first transfer roller 5Y. The first transfer roller 5Y transfers the toner image from the photoreceptor 1Y to the intermediate transfer belt 20 by electrostatic force.

Toner images of the individual colors are sequentially transferred from the first to fourth image forming units 10Y, 10M, 10C, and 10K to the intermediate transfer belt 20 so as to be superimposed on top of each other. The intermediate transfer belt 20 having the four superimposed toner images transferred thereto through the first to fourth image forming units 10Y, 10M, 10C, and 10K reaches the second transfer section composed of the support roller 24 and the second transfer roller 26.

The second transfer roller 26 is a transfer roller that comes into direct contact with a surface of a recording medium and is disposed outside the intermediate transfer belt 20 at a position opposite the support roller 24. A sheet of recording paper P (an example of a recording medium) is fed into a gap where the second transfer roller 26 is in contact with the intermediate transfer belt 20 via a feed mechanism. When a second transfer bias is applied to the second transfer roller 26, electrostatic force directed from the intermediate transfer belt 20 toward the recording paper P acts on the toner image, thereby transferring the toner image from the intermediate transfer belt 20 to the recording paper P.

The recording paper P having the toner image transferred thereto is transported into a nip between a pair of rollers of the fixing device 28, where the toner image is fixed to the recording paper P.

The toners and developers used in the image forming apparatuses according to the present exemplary embodiment are not particularly limited, and known electrophotographic toners and developers may both be used.

The recording media used in the image forming apparatuses according to the present exemplary embodiment are not particularly limited. Examples of recording media include sheets of paper for use in electrophotographic copiers and printers; and OHP sheets.

### EXAMPLES

The exemplary embodiment of the present disclosure will be described in detail with reference to the following examples, although these examples are not intended to limit the exemplary embodiment of the present disclosure in any way. In the description, “parts” refers to “parts by mass” unless otherwise specified.

### Example 1

### Formation of Elastic Layer

### Formation of Elastic Foam

EP70 (manufactured by Inoac Corporation) is used as an elastic foam and is cut into a cylindrical shape with an outer diameter of 26 mm and an inner diameter of 14 mm to obtain a cylindrical elastic foam.

The resulting elastic foam has an open-cell structure with a cell size of 400 μm and a density of 70 kg/m³.

### Formation of Conductive Covering Layer

The elastic foam obtained by the method described above is immersed in a treatment liquid obtained by mixing an aqueous dispersion containing 36% by mass of carbon black dispersed therein with an acrylic emulsion (manufactured by Zeon Corporation, the trade name “Nipol LX852”) in a mass ratio of 1:1 at 20° C. for 10 minutes.

The elastic foam having the treatment liquid deposited thereon is then dried by heating in a cure oven set to 100° C. for 60 minutes to remove moisture and crosslink the acrylic resin. By crosslinking, the acrylic resin is cured to form a conductive covering layer containing carbon black on the exposed surface of the elastic foam.

Thus, an elastic layer including an elastic foam and a conductive covering layer covering the exposed surface of the elastic foam is obtained.

A conductive support member (stainless steel, diameter: 14 mm) having adhesive applied to the surface thereof is then inserted into the resulting elastic layer to form a roller member.

Formation of Intermediate Layer

A coating liquid for forming an intermediate layer is obtained by mixing together 70 parts of a urethane oligomer (manufactured by Nippon Synthetic Chemical Industry Co., Ltd., urethane acrylate UV3700B), 30 parts of a urethane monomer (manufactured by Kyoeisha Chemical Co., Ltd., isomyristyl acrylate), 0.5 parts of a polymerization initiator (manufactured by Ciba Specialty Chemicals Corporation, 1-hydroxycyclohexyl phenyl ketone Irgacure 184), and 3 parts of alkyltrimethylammonium perchlorate (the trade name “LXN-30”, manufactured by Osaka Soda Co., Ltd.). The resulting coating liquid for forming an intermediate layer is applied to the elastic layer using a die coater. While being rotated, the coating is irradiated with UV light at a UV irradiation intensity of 700 mW/cm² for 5 seconds. By this procedure, an intermediate layer with a thickness of 1 mm is formed.

### Formation of Surface Layer

Subsequently, a coating liquid for forming a surface layer is obtained by adding 5% by mass of a curing agent (WH-1, manufactured by Henkel Japan Ltd.) to a urethane resin coating material (EMRALON T-862A, manufactured by Henkel Japan Ltd.) and mixing them together. The resulting coating liquid for forming a surface layer is applied to the intermediate layer by spray coating. The coating is cured by heating at 120° C. for 20 minutes to form a surface layer with a thickness of 20 μm.

Thus, a conductive roller having a volume resistance value of 10^{6.8} Ω (as measured when a voltage of 1,000 V is applied) is obtained.

### Example 2

A conductive roller is obtained as in Example 1 except that, in Example 1, RR90 (manufactured by Inoac Corporation) at the center of the tolerance range is used instead of EP70 as the elastic foam.

### Example 3

A conductive roller is obtained as in Example 1 except that, in Example 1, RR90 (manufactured by Inoac Corporation) with high density is used instead of EP70 as the elastic foam, and the amount of urethane monomer in the coating liquid for forming an intermediate layer is 50 parts.

### Example 4

A conductive roller is obtained as in Example 1 except that, in Example 1, RR90 (manufactured by Inoac Corporation) with high density is used instead of EP70 as the elastic foam, and the amount of urethane monomer in the coating liquid for forming an intermediate layer is 40 parts.

### Example 5

A conductive roller is obtained as in Example 1 except that, in Example 1, RMM (manufactured by Inoac Corporation) is used instead of EP70 as the elastic foam, and the amount of urethane oligomer in the coating liquid for forming an intermediate layer is 80 parts.

### Example 6

A conductive roller is obtained as in Example 1 except that, in Example 1, RMM (manufactured by Inoac Corporation) is used instead of EP70 as the elastic foam, and the amount of urethane oligomer in the coating liquid for forming an intermediate layer is 90 parts.

### Example 7

A conductive roller is obtained as in Example 1 except that, in Example 1, UW-1527F (manufactured by Ube Industries, Ltd.) is used instead of EMRALON T-862A as the urethane resin coating material in the coating liquid for forming a surface layer.

### Example 8

A conductive roller is obtained as in Example 1 except that, in Example 1, ST053D (manufactured by Ube Industries, Ltd.) is used instead of EMRALON T-862A as the urethane resin coating material in the coating liquid for forming a surface layer.

### Example 9

A conductive roller is obtained as in Example 1 except that, in Example 1, UW5502 (manufactured by Ube Industries, Ltd.) is used instead of EMRALON T-862A as the urethane resin coating material in the coating liquid for forming a surface layer.

### Example 10

A conductive roller is obtained as in Example 1 except that, in Example 1, UW5002E (manufactured by Ube Industries, Ltd.) is used instead of EMRALON T-862A as the urethane resin coating material in the coating liquid for forming a surface layer.

### Example 11

A conductive roller is obtained as in Example 1 except that, in Example 1, RR26 (manufactured by Inoac Corporation) is used instead of EP70 as the elastic foam.

### Example 12

A conductive roller is obtained as in Example 1 except that, in Example 1, RMM (manufactured by Inoac Corporation) is used instead of EP70 as the elastic foam.

### Example 13

A conductive roller is obtained as in Example 1 except that, in Example 1, RR90 (manufactured by Inoac Corporation) at the upper limit of the tolerance range is used instead of EP70 as the elastic foam.

### Comparative Example 1

A conductive roller is obtained as in Example 1 except that, in Example 1, no conductive covering layer is formed, RMM (manufactured by Inoac Corporation) is cut into a cylindrical shape, a conductive support member is inserted therein, and an intermediate layer is formed.

### Evaluation

### Paper Releasability

A paper feed bench using a second transfer unit of ApeosPort-VII C7788 manufactured by FUJIFILM Business Innovation Corp. is prepared. Sheets of 52 gsm paper are fed to evaluate releasability.

G1 (A): The paper is not wound around the conductive roller or the intermediate transfer belt, and the releasability of the paper from the conductive roller is good.

G2 (B): The paper is slightly wound around the conductive roller or the intermediate transfer belt, but the number of paper jams that occur is smaller than that for G3.

G3 (C): The paper is wound around the conductive roller or the intermediate transfer belt, and paper jams occur on all sheets.

TABLE 1

| | Elastic layer | | | | | | | Intermediate layer | |
|---|---|---|---|---|---|---|---|---|---|
| | Elastic foam | | | | Presence or | | Volume | | Volume |
| | Presence or | | | | absence of | Young's | resistance | Young's | resistance |
| | absence of | Type | Cell | | conductive | modulus | value | modulus | value |
| | open-cell | (Product | size | Density | covering | Yd | (logΩ) | Ym | (logΩ) |
| | structure | No.) | (μm) | (kg/m³) | layer | (MPa) | at 10 V | (MPa) | at 100 V |
| Ex. 1 | Present | EP70 | 400 | 70 | Present | 0.12 | 3.9 | 7.0 | 8.8 |
| Ex. 2 | Present | RR90 | 450 | 85 | Present | 0.25 | 4.0 | 7.0 | 8.8 |
| Ex. 3 | Present | RR90 | 550 | 90 | Present | 0.40 | 4.5 | 3.2 | 8.8 |
| Ex. 4 | Present | RR90 | 550 | 90 | Present | 0.40 | 4.5 | 5.0 | 8.8 |
| Ex. 5 | Present | RMM | 500 | 55 | Present | 0.09 | 3.8 | 8.5 | 8.8 |
| Ex. 6 | Present | RMM | 500 | 55 | Present | 0.09 | 3.8 | 9.5 | 8.8 |
| Ex. 7 | Present | EP70 | 400 | 70 | Present | 0.12 | 3.9 | 7.0 | 8.8 |
| Ex. 8 | Present | EP70 | 400 | 70 | Present | 0.12 | 3.9 | 7.0 | 8.8 |
| Ex. 9 | Present | EP70 | 400 | 70 | Present | 0.12 | 3.9 | 7.0 | 8.8 |
| Ex. 10 | Present | EP70 | 400 | 70 | Present | 0.12 | 3.9 | 7.0 | 8.8 |
| Ex. 11 | Present | RR26 | 600 | 35 | Present | 0.05 | 4.0 | 7.0 | 8.8 |
| Ex. 12 | Present | RMM | 500 | 55 | Present | 0.07 | 3.9 | 7.0 | 8.8 |
| Ex. 13 | Present | RR90 | 580 | 95 | Present | 0.35 | 4.0 | 7.0 | 8.8 |
| Comp. | Present | EP70 | 400 | 70 | Absent | 0.12 | 12.5 | 0.07 | 12.0 |
| Ex. 1 | | | | | | | | | |

| | Surface layer | | Conductive roller | | | | |
|---|---|---|---|---|---|---|---|
| | | Volume | | | | Volume | |
| | Young's | resistance | | | Film | resistance | |
| | modulus | value | | | thickness | value | |
| | Ys | (logΩ) | Young's modulus | | Td/(Td + | (logΩ) | Evaluation |
| | (MPa) | at 50 V | Ym/Yd | Ys/Ym | Tm + Ts) | at 1,000 V | Releasability |
| Ex. 1 | 270 | 10.0 | 58.3 | 38.6 | 0.15 | 6.8 | G1 (A) |
| Ex. 2 | 270 | 10.0 | 28.0 | 38.6 | 0.15 | 6.9 | G1 (A) |
| Ex. 3 | 270 | 10.0 | 8.0 | 84.4 | 0.15 | 7.1 | G2 (B) |
| Ex. 4 | 270 | 10.0 | 12.5 | 54.0 | 0.15 | 7.1 | G1 (A) |
| Ex. 5 | 270 | 10.0 | 94.4 | 31.8 | 0.15 | 6.9 | G1 (A) |
| Ex. 6 | 270 | 10.0 | 105.6 | 28.4 | 0.15 | 6.8 | G2 (B) |
| Ex. 7 | 50 | 10.0 | 58.3 | 7.1 | 0.15 | 6.8 | G2 (B) |
| Ex. 8 | 75 | 10.0 | 58.3 | 10.7 | 0.15 | 6.8 | G1 (A) |
| Ex. 9 | 600 | 10.0 | 58.3 | 85.7 | 0.15 | 6.8 | G1 (A) |
| Ex. 10 | 1,000 | 10.0 | 58.3 | 142.9 | 0.15 | 6.8 | G2 (B) |
| Ex. 11 | 270 | 10.0 | 140.0 | 38.6 | 0.15 | 6.8 | G2 (B) |
| Ex. 12 | 270 | 10.0 | 100.0 | 38.6 | 0.15 | 6.8 | G1 (A) |
| Ex. 13 | 270 | 10.0 | 20.0 | 38.6 | 0.15 | 6.8 | G1 (A) |
| Comp. | 270 | 10.0 | 0.6 | 3,857.1 | 0.15 | 11.0 | G3 (C) |
| Ex. 1 | | | | | | | |

As can be seen from Table 1, the conductive rollers of the Examples may provide high paper releasability compared to the conductive roller of the Comparative Example.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A conductive roller comprising:
a support member;
an elastic layer disposed on an outer peripheral surface of the support member;
an intermediate layer disposed on an outer peripheral surface of the elastic layer; and
a surface layer disposed on an outer peripheral surface of the intermediate layer,
wherein the elastic layer includes a cylindrical elastic foam and a conductive covering layer covering an exposed surface of the elastic foam, and
wherein a Young's modulus Yd of the elastic layer and a Young's modulus Ym of the intermediate layer satisfy a relationship Yd<Ym.

2. The conductive roller according to claim 1, wherein the Young's modulus Yd of the elastic layer and the Young's modulus Ym of the intermediate layer satisfy a relationship 10≤Ym/Yd≤100.

3. The conductive roller according to claim 1, wherein the Young's modulus Yd of the elastic layer is 50 kPa or more and 500 kPa or less.

4. The conductive roller according to claim 2, wherein the Young's modulus Yd of the elastic layer is 50 kPa or more and 500 kPa or less.

5. The conductive roller according to claim 1, wherein the Young's modulus Ym of the intermediate layer and a Young's modulus Ys of the surface layer satisfy a relationship Ym<Ys.

6. The conductive roller according to claim 2, wherein the Young's modulus Ym of the intermediate layer and a Young's modulus Ys of the surface layer satisfy a relationship Ym<Ys.

7. The conductive roller according to claim 3, wherein the Young's modulus Ym of the intermediate layer and a Young's modulus Ys of the surface layer satisfy a relationship Ym<Ys.

8. The conductive roller according to claim 4, wherein the Young's modulus Ym of the intermediate layer and a Young's modulus Ys of the surface layer satisfy a relationship Ym<Ys.

9. The conductive roller according to claim 5, wherein the Young's modulus Ym of the intermediate layer and the Young's modulus Ys of the surface layer satisfy a relationship 5≤Ys/Ym≤100.

10. The conductive roller according to claim 6, wherein the Young's modulus Ym of the intermediate layer and the Young's modulus Ys of the surface layer satisfy a relationship 5≤Ys/Ym≤100.

11. The conductive roller according to claim 7, wherein the Young's modulus Ym of the intermediate layer and the Young's modulus Ys of the surface layer satisfy a relationship 5≤Ys/Ym≤100.

12. The conductive roller according to claim 8, wherein the Young's modulus Ym of the intermediate layer and the Young's modulus Ys of the surface layer satisfy a relationship 5≤Ys/Ym≤100.

13. The conductive roller according to claim 1, wherein a thickness Td of the elastic layer, a thickness Tm of the intermediate layer, and a thickness Ts of the surface layer satisfy a relationship Td>Tm>Ts and a relationship 0.05≤Td/(Td+Tm+Ts)≤0.45.

14. The conductive roller according to claim 2, wherein a thickness Td of the elastic layer, a thickness Tm of the intermediate layer, and a thickness Ts of the surface layer satisfy a relationship Td>Tm>Ts and a relationship 0.05≤Td/(Td+Tm+Ts)≤0.45.

15. The conductive roller according to claim 3, wherein a thickness Td of the elastic layer, a thickness Tm of the intermediate layer, and a thickness Ts of the surface layer satisfy a relationship Td>Tm>Ts and a relationship 0.05≤Td/(Td+Tm+Ts)≤0.45.

16. The conductive roller according to claim 1, wherein the elastic foam has an open-cell structure.

17. The conductive roller according to claim 16, wherein the elastic foam has a density of 50 kg/m³ or more and 90 kg/m³ or less.

18. A transfer device comprising the conductive roller according to claim 1.

19. A process cartridge attachable to and detachable from an image forming apparatus, the process cartridge comprising:
an image carrier; and
the transfer device according to claim 18.

20. An image forming apparatus comprising:
an image carrier;
a charging device that charges a surface of the image carrier;
an electrostatic latent image forming device that forms an electrostatic latent image on the charged surface of the image carrier;
a developing device that develops the electrostatic latent image formed on the surface of the image carrier with a developer containing toner to form a toner image; and
transfer device according to claim 18, wherein the transfer device transfers the toner image to a surface of a recording medium.
